(19) United States
(12) Patent Application Publication
(10) Pub. No.: US 2008/0148882 A1
(43) Pub. Date: Jun. 26, 2008

(54) BEARING ARRANGEMENT FOR AN AUXILIARY DRIVE OUTPUT SHAFT

(75) Inventors: Hermann Lanz, Frickingen (DE); Walter Muller, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/960,917

(22) Filed: Dec. 20, 2007

(30) Foreign Application Priority Data
Dec. 22, 2006 (DE) 10 2006 061 258.2

(51) Int. Cl. F16C 19/24; B60K 17/28

(52) U.S. Cl. 74/15.82; 384/548

(57) ABSTRACT

A bearing arrangement for an auxiliary drive output shaft (1), in particular for a PTO shaft (1) in a multi-speed transmission of a commercial vehicle. The auxiliary drive output shaft (1) is driven by an intermediate gear wheel (3) of the transmission and is supported by at least one bearing (7, 10) on the drive input side and a bearing (9) on the drive output side of the auxiliary drive output shaft (1). The bearing on the drive input side is at least one radial bearing (7, 10) and the bearing on the drive output side is a conical-roller bearing (9).

This application claims priority from German Application Serial No. 10 2006 061 258.2 filed Dec. 22, 2006.

### FIELD OF THE INVENTION

The present invention concerns a bearing arrangement for an auxiliary drive output shaft.

### BACKGROUND OF THE INVENTION

In automotive technology manual shift transmissions, automated transmissions, and automatic transmissions are known in commercial vehicles. Such transmissions can also be equipped with auxiliary drive output shafts by means of which auxiliary drives of the commercial vehicle can be powered. Examples of such auxiliary drives are those provided for hydraulic pumps, turbines or like aggregates. In commercial vehicles, for example, vehicle body superstructures can be powered by such aggregates.

A bearing arrangement is needed in the transmission to support the auxiliary drive output shaft. As the auxiliary drive output shaft, for example a PTO shaft can be provided, which in the known transmissions is driven via spur gearing by an intermediate gear. For this, a bearing on the drive input side of the PTO shaft and a bearing on its drive output side are provided. In the known bearing arrangements, these bearings on the input and output sides are, in each case, conical-roller bearings.

To enable retrofitting of the PTO shaft on the vehicle as well, even in the basic design of the transmission without the PTO shaft, at least the outer ring of the conical-roller bearing on the drive input side is already mounted in the transmission housing. Otherwise, retrofitting of the PTO shaft later, while in the field would no longer be possible. This, however, entails additional costs for producing the basic structure of the transmission.

Further, it has been shown that the gearing force, which occurs during operation of the PTO shaft, acts almost exclusively on the drive output side of the bearing arrangement. Consequently, this relieves the axial load on the conical-roller bearing on the drive input side and, because of the existing axial play, this reduces the amount of support provided by the conical rollers in the bearing on the drive input side. Accordingly, the life of the known bearing arrangement is made shorter. Owing to the axially incorrect position of the conical-roller bearing the PTO shaft can adopt a skewed position and this, too, shortens the life of the conical-roller bearing on the drive output side.

A further disadvantage of an axial bearing in the bearing arrangement is that it has to be adjusted during assembly. When assembly is being carried out in the context of a retrofit, this can lead to problems.

Thus, the purpose of the present invention is to propose a bearing arrangement of the type described at the start, which can be retrofitted as simply as possible and which is also inexpensive.

### SUMMARY OF THE INVENTION

Accordingly, a bearing arrangement is proposed for an auxiliary drive output shaft, in particular a PTO shaft in a transmission of a commercial vehicle, such that the auxiliary drive output shaft can be driven by an intermediate gear of the transmission and such that at least one bearing is arranged on the drive input side of the auxiliary drive output shaft and a bearing is arranged on the drive output side thereof. According to the invention, at least one radial bearing or the like is provided as the bearing on the drive input side. This radial bearing is characterized by only a low axial load capacity.

In this way, even retrofitting an auxiliary drive output shaft, in particular a PTO shaft, in the commercial vehicle is made possible without problems. Thanks to the use of a radial bearing as the bearing on the drive input side, no special provisions need be made in the basic design of the transmission, namely, without the auxiliary drive output shaft, for such an output shaft. Moreover, radial bearings are particularly simple to assemble and require no additional adjustments during retrofitting. Consequently, the bearing arrangement enables particularly inexpensive and simple retrofitting of a PTO shaft. The bearing used on the drive output side of the auxiliary drive output shaft is a conical-roller bearing. This is advantageous because the gearing force, between the auxiliary drive output shaft and the intermediate gear, acts almost exclusively in the direction of the drive output. Thus, the conical-roller bearing on the drive output side can absorb this axial force.

The radial bearing, used on the drive input side can preferably be a cylindrical-roller bearing, a grooved ball bearing or the like. Thanks to the use of this bearing on the drive input side, the auxiliary drive output shaft consisting of a PTO shaft, can be assembled and fitted into the transmission housing from the drive output side for retrofitting purposes. In this way, the retrofit can be carried out subsequently in the field without problems, i.e., near the customer during the service of the vehicle.

Preferably, the PTO shaft can be connected to the transmission, via an already existing reverse-gear intermediate gear. Other possible arrangements in the transmission can also be considered.

In the bearing arrangement, according to the invention, the maximum outer diameter of the outer ring of the radial bearing on the drive input side is chosen such that it can be pushed past the outer diameter of the reverse-gear wheel so that there is no inter-component interference. In this way, the PTO shaft can be introduced into the transmission housing and fitted without problems. It is particularly advantageous for the radial bearing on the drive input side to be designed with a clearance fit in the transmission housing. The outer ring of the radial bearing can then be fitted simply into the transmission housing without need for additional work steps.

### BRIEF DESCRIPTION OF THE DRAWINGS

The invention will now be described, by way of example, with reference to the accompanying drawings in which:

FIG. 1 is a schematic partial, sectional view of a transmission housing with a first embodiment of the bearing arrangement according to the invention for an auxiliary drive output shaft, and

FIG. 2 is a schematic partial, sectional view of the transmission housing with a second embodiment of the bearing arrangement according to the invention.

### DETAILED DESCRIPTION OF THE INVENTION

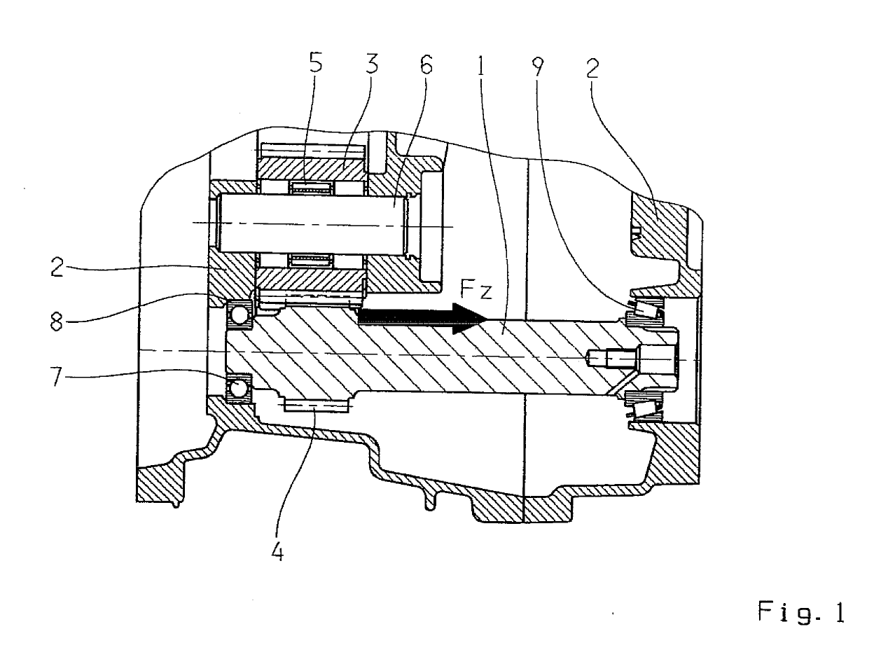

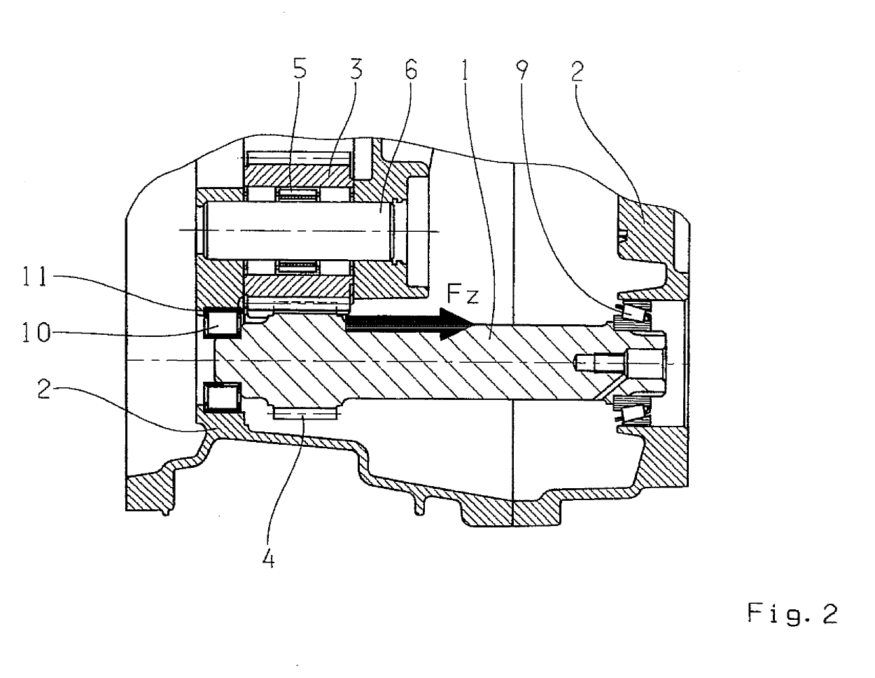

FIGS. 1 and 2 show two different embodiments of a bearing arrangement, according to the invention, for a PTO shaft 1 that constitutes an auxiliary drive output shaft (only partially illustrated) in a transmission for a commercial vehicle.

The PTO shaft 1 is fitted into the transmission with a bearing arrangement. Regardless of the respective embodiment, the bearing arrangement comprises a bearing on the drive input side and a bearing on the drive output side in a transmission housing 2. The PTO shaft 1 is driven by spur gearing via a reverse-gear intermediate gear 3. The spur gearing comprises the reverse-gear intermediate gear 3 and gear teeth 4 formed on the PTO shaft 1 itself. The reverse-gear intermediate gear 3 is mounted to rotate, via a roller bearing 5, on a reverse-gear gudgeon pin 6.

A radial bearing is provided on the drive input side of the PTO shaft 1, which, in the embodiment shown in FIG. 1, is a grooved ball bearing 7. The grooved ball bearing 7 fits into the transmission housing 2 with a clearance fit. The maximum outer diameter of an outer ring 8 of the grooved ball bearing 7 is chosen such that it can be pushed past the outer diameter of the reverse-gear intermediate gear 3. Thus, the PTO shaft 1 can be fitted into the transmission housing 2 from the drive output side, i.e., from the right in the plane of the drawing, even later on. The bearing on the drive output side of the PTO shaft 1 is a conical-roller bearing 9, which can absorb the gearing force acting in the drive output direction, as indicated by an arrow F_{z} in FIGS. 1 and 2.

FIG. 2 shows a second embodiment of the bearing arrangement, according to the invention. In contrast to the first embodiment, shown in FIG. 1, in this second embodiment, a cylindrical-roller bearing 10 is provided as the bearing on the drive input side. In the second embodiment as well, the bearing on the drive output side is the conical-roller bearing 9, which absorbs the axial gearing force F_{z}. The cylindrical-roller bearing 10 again has an outer ring 11 whose maximum outer diameter is such that it can be pushed past the outer diameter of the reverse-gear intermediate gear 3. Again, the outer ring 11 of the cylindrical-roller bearing 10 fits into the transmission housing 2 with a clearance fit.

### REFERENCE NUMERALS

1 PTO shaft
2 transmission housing
3 reverse-gear intermediate gear
4 gearing
5 roller bearing
6 reverse-gear gudgeon pin
7 grooved ball bearing
8 outer ring of the grooved ball bearing
9 conical-roller bearing
10 cylindrical-roller bearing
11 outer ring of the cylindrical-roller bearing
F_{z} gearing force

1-7. (canceled)

8. A bearing arrangement for an auxiliary drive output shaft (1), of a transmission of a commercial vehicle, in which an intermediate gear wheel (3) of the transmission drives the auxiliary drive output shaft (1), and at least one bearing (7, 10), on a drive input side, and a bearing (9), on an drive output side, being arranged on the auxiliary drive output shaft (1), and the bearing on the drive input side being at least one radial bearing (7, 10) and the bearing on the drive output side being a conical-roller bearing (9).

9. The bearing arrangement according to claim 8, wherein the radial bearing on the drive input side is a cylindrical-roller bearing (10).

10. The bearing arrangement according to claim 8, wherein the radial bearing on the drive input side is a grooved ball bearing (7).

11. The bearing arrangement according to claim 8, wherein the auxiliary drive output shaft is a power take off (PTO) shaft (1) and is retrofit into a transmission housing (2) from the drive output side.

12. The bearing arrangement according to claim 8, wherein the auxiliary drive output shaft is a power take off (PTO) shaft (1) and is connected to the transmission via a reverse-gear intermediate gear (3).

13. The bearing arrangement according to claim 11, wherein a maximum outer diameter of an outer ring (8, 11) of the radial bearing on the drive input side of the power take off (PTO) shaft (1) is such that the outer ring (8, 11) is freely installed past an outer diameter of the reverse-gear intermediate gear (3).

14. The bearing arrangement according to claim 8, wherein the auxiliary drive output shaft is a power take off (PTO) shaft (1) and an outer ring (8, 11) of the radial bearing on the drive input side of the power take off (PTO) shaft (1) fits into the transmission housing (2) with a clearance fit.

15. An arrangement supporting a power take off shaft (1) in a transmission of a commercial vehicle, the arrangement comprising:
the power take off shaft (1) having an input end and an output end;
an intermediate gear (3) communicating with the input end of the power take off shaft for rotationally driving the power take off shaft (1);
one of a radial, cylindrical-roller bearing (10) and a radial, grooved ball bearing (7) rotatably supporting the input end of the power take of shaft (1) and having an outer ring (8, 11);
a conical roller bearing (9) rotatably supporting the output end of the power take of shaft (1);
the outer ring (8, 11) being supported, via a clearance fit, in a transmission housing (2) and being installed in the transmission housing (2) via the input side of the transmission housing (2) supporting the conical roller bearing (9); and
the intermediate gear (3) rotatably engaging the power take off shaft (1) at an axial location along the power take of shaft (1), between the conical roller bearing (9) and the one of the radial, cylindrical-roller bearing (10) and the radial, grooved ball bearing (7).
